(19) United States
(12) Patent Application Publication
(10) Pub. No.: US 2020/0326724 A1
(43) Pub. Date: Oct. 15, 2020

(54) DELIVERY SYSTEM, MANAGING SERVER, COMPUTER-READABLE STORAGE MEDIUM, AND MANAGEMENT METHOD

(71) Applicant: SoftBank Group Corp., Tokyo (JP)

(72) Inventor: Masayoshi Son, Tokyo (JP)

(21) Appl. No.: 16/596,769

(22) Filed: Oct. 9, 2019

(30) Foreign Application Priority Data
Apr. 11, 2019 (JP) 2019-075698

(51) Int. Cl. G05D 1/02; G06Q 10/08; G05D 1/00

(52) U.S. Cl. CPC G05D 1/0276; G06Q 10/08345; B60P 3/007; G05D 1/0088; G06Q 10/08355

(57) ABSTRACT

A delivery system is provided, the delivery system including: a superordinate vehicle; a subordinate vehicle; and a managing server that manages delivery of a package, wherein the managing server has: a delivery destination information acquiring unit that acquires delivery destination information related to a delivery destination of a package; a transport managing unit that performs management to make the package transport by the superordinate vehicle and the subordinate vehicle by automated transportation to a delivery destination-supporting geographical point corresponding to the delivery destination of the package based on the delivery destination information; and a registered person selecting unit that selects a registered person to deliver the package having been transported to the delivery destination-supporting geographical point, the registered person being selected from a plurality of pre-registered registered persons, the package being delivered from the delivery destination-supporting geographical point to the delivery destination.

The contents of the following Japanese patent application are incorporated herein by reference: 2019-075698 filed in JP on Apr. 11, 2019

### BACKGROUND

### 1. Technical Field

The present invention relates to a delivery system, a managing server, a computer-readable storage medium, and a management method.

### 2. Related Art

There are known package managing systems to manage packages to be delivered (see Patent Literature 1, for example).

### PRIOR ART LITERATURE

### Patent Literature

[Patent Literature 1] Japanese Patent Application Publication No. 2014-189361

### SUMMARY

It is desirable to provide a technology that can appropriately manage delivery of packages.

### BRIEF DESCRIPTION OF THE DRAWINGS

FIG. 1 schematically illustrates an exemplary delivery system 10.

FIG. 2 schematically illustrates an exemplary flow of processing to be performed by the delivery system 10.

FIG. 3 is an explanatory figure for explaining contents of processing to be performed by the delivery system 10.

FIG. 4 schematically illustrates an exemplary functional configuration of a managing server 100.

FIG. 5 schematically illustrates an exemplary hardware configuration of a computer 1200 to function as the managing server 100.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

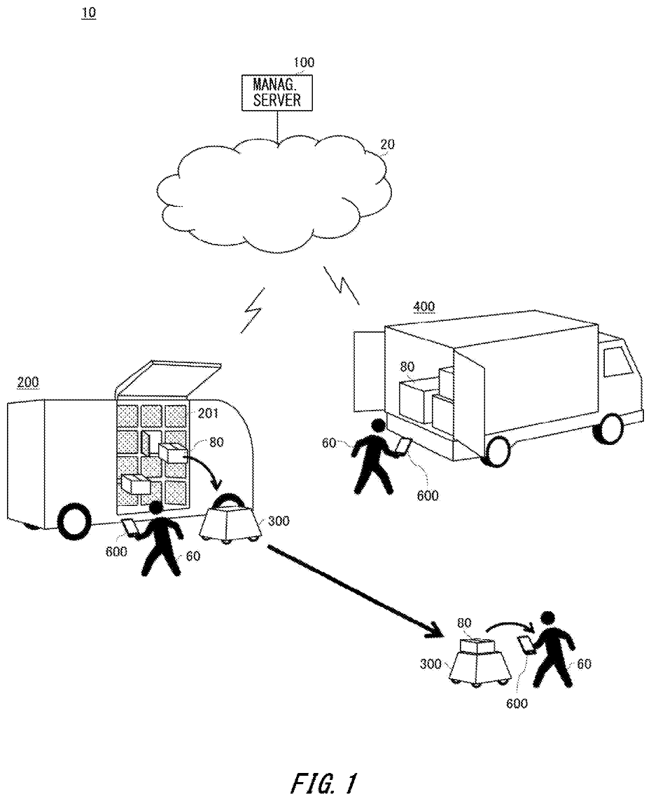

FIG. 1 schematically illustrates an exemplary delivery system 10. The delivery system 10 according to the present embodiment includes a superordinate vehicle 200, a subordinate vehicle 300, and a managing server 100.

The superordinate vehicle 200 can transport a plurality of packages 80. The superordinate vehicle 200 may be capable of automated driving. The superordinate vehicle 200 has a plurality of housing units 201 each of which can house a package 80, for example. The housing units 201 can house various types of packages 80.

The superordinate vehicle 200 may be loaded with packages 80 at any location. The superordinate vehicle 200 is loaded with packages 80 collected by a delivery company, for example. In addition, the superordinate vehicle 200 is loaded with packages 80 at a so-called logistics center, for example. In addition, for example, the superordinate vehicle 200 travels to the position of a sender who is to send a package 80, and picks up and is loaded with the package 80. Loading of packages 80 to the superordinate vehicle 200 may be performed manually, and also may be performed by a machine such as a robot.

The subordinate vehicle 300 can transport at least one package 80. The subordinate vehicle 300 transports a package 80 received from the superordinate vehicle 200, for example. The subordinate vehicle 300 may be capable of automated driving. The number of subordinate vehicles 300 corresponding to the superordinate vehicle 200 may be one or larger than one.

The managing server 100 manages delivery of packages. The managing server 100 according to the present embodiment performs management to transport a package 80 to a delivery destination-supporting geographical point corresponding to the delivery destination by the superordinate vehicle 200, the superordinate vehicle 200 and a subordinate vehicle 300, or a delivery vehicle 400, selects a registered person 60 among a plurality of pre-registered registered persons 60 who is to deliver the package 80 transported to the delivery destination-supporting geographical point from the delivery destination-supporting geographical point to the delivery destination, and requests the registered person 60 to deliver the package 80.

The delivery destination-supporting geographical point may be decided arbitrarily. For example, the delivery destination-supporting geographical point selected is a geographical point which is near the delivery destination, and at which the package 80 can be passed over to and received by the registered person 60 easily. The managing server 100 may decide the delivery destination-supporting geographical point based on delivery destination information related to the delivery destination of the package 80.

The managing server 100 and the superordinate vehicle 200 communicate with each other via a network 20. The network 20 may include a cellular communication network and the Internet. The cellular communication network may conform to any of the 3G (3rd Generation) communication standard, LTE (Long Term Evolution) communication standard, 5G (5th Generation) communication standard, or communication standards of and following the 6G (6th Generation) communication standard. The superordinate vehicle 200 may access a cellular communication network via a wireless base station, and may access a cellular communication network via a WiFi (registered trademark) connection.

The managing server 100 and a subordinate vehicle 300 may communicate with each other via the network 20 similar to communication between the managing server 100 and the superordinate vehicle 200. In addition, the managing server 100 and a subordinate vehicle 300 may communicate with each other via the superordinate vehicle 200. The superordinate vehicle 200 and a subordinate vehicle 300 may communicate with each other via the network 20. In addition, the superordinate vehicle 200 and a subordinate vehicle 300 may communicate with each other via a WiFi connection.

The superordinate vehicle 200 transports a package 80 to a delivery destination-supporting geographical point according to a transport instruction received from the managing server 100. In addition, the superordinate vehicle 200 makes a subordinate vehicle 300 transport the package 80 to the delivery destination-supporting geographical point according to the transport instruction received from the managing server 100. Receipt of the package 80 by the subordinate vehicle 300 from the superordinate vehicle 200 may be performed by any method. For example, the package 80 in the superordinate vehicle 200 is passed to the subordinate vehicle 300 manually. In addition, for example, the package 80 is passed from the superordinate vehicle 200 to the subordinate vehicle 300 by a mechanical arm or the like provided to at least any one of the superordinate vehicle 200 and the subordinate vehicle 300.

The delivery vehicle 400 may be a vehicle driven by a courier. For example, the managing server 100 sends a transport instruction to a mobile communication terminal such as a smartphone owned by the courier, a terminal dedicated to delivery tasks, or the like. The courier transports the package 80 to the delivery destination-supporting geographical point according to the transport instruction.

The registered person 60 may not be a full-time courier belonging to a delivery company, but may be someone who is registered for the job of operating as a courier temporarily. The managing server 100 receives the registration from a mobile communication terminal 600 of the registered person 60, for example.

The mobile communication terminal 600 may be a mobile phone such as a smartphone, a tablet terminal, or the like. Terminal identification information may be any information as long as it allows identification of the mobile communication terminal 600.

The registered person 60 installs a dedicated application in the mobile communication terminal 600 when he/she is to be registered in the managing server 100, for example. The managing server 100 acquires various types of information from the mobile communication terminal 600 in cooperation with the application installed in the mobile communication terminal 600.

The managing server 100 may acquire attribute information such as the name, address, gender, or age of the registered person 60. The managing server 100 may acquire the terminal identification information of the mobile communication terminal 600. The managing server 100 may acquire positional information of the mobile communication terminal 600.

The managing server 100 may acquire travel capability information indicating the travel capability of the registered person 60. The travel capability information indicates a means for travelling available for the registered person 60, for example. Examples of the means for travelling include walking, a bicycle, a motor bicycle, a car and the like.

The managing server 100 and the mobile communication terminal 600 communicate with each other via the network 20. The mobile communication terminal 600 may access a cellular communication network via a wireless base station, and may access a cellular communication network via a WiFi (registered trademark) connection.

The registered person 60 who received from the managing server 100 request information requesting him/her to deliver the package 80, and accepted the request travels to the delivery destination-supporting geographical point by a time designated by the managing server 100, receives the package 80 at the delivery destination-supporting geographical point, and delivers the package 80 to the delivery destination designated by the managing server 100.

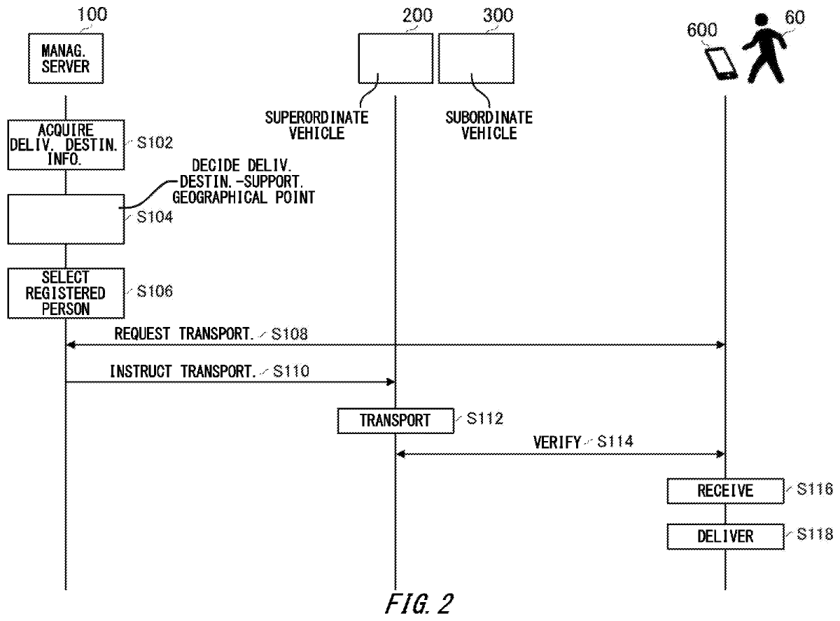

FIG. 2 schematically illustrates an exemplary flow of processing to be performed by the delivery system 10. Here, a flow of processing in which a package 80 is transported by the superordinate vehicle 200 and a subordinate vehicle 300 to a delivery destination-supporting geographical point by automated delivery, and the package 80 is delivered by the registered person 60 from the delivery destination-supporting geographical point to the delivery destination is schematically illustrated.

At Step 102 (steps are abbreviated to S′s in some cases), the managing server 100 acquires delivery destination information about the delivery destinations of a plurality of packages 80 loaded onto the superordinate vehicle 200. At S104, the managing server 100 decides delivery destination-supporting geographical points for the plurality of packages 80 based on the delivery destination information acquired at S102. The managing server 100 may decide a delivery destination-supporting geographical point for each of the plurality of packages 80. In addition, the managing server 100 may decide one delivery destination-supporting geographical point for the plurality of packages 80.

At S106, the managing server 100 selects a registered person 60 from a plurality of registered persons 60 who is to deliver a package 80 transported to a delivery destination-supporting geographical point from the delivery destination-supporting geographical point to the delivery destination. If the managing server 100 decided a delivery destination-supporting geographical point for each of the plurality of packages 80, the managing server 100 may select a registered person 60 for each of a plurality of delivery destination-supporting geographical points. If the managing server 100 decided a delivery destination-supporting geographical point for the plurality of packages 80, the managing server 100 may select a plurality of registered persons 60, each registered person 60 being a person to deliver one of the plurality of packages 80.

For example, the managing server 100 selects a registered person 60 based on positional information of the plurality of registered persons 60. As a specific example, the managing server 100 preferentially selects a registered person 60 among the plurality of registered persons 60 whose position indicated by positional information is closer to the delivery destination-supporting geographical point.

At S108, the managing server 100 sends a delivery request about the package 80 to a mobile communication terminal 600 of the registered person 60 selected at S106. If the delivery request is not accepted by the registered person 60, the managing server 100 may select another registered person 60, and sends a delivery request about the package 80 to a mobile communication terminal 600 of the newly selected registered person 60. Here, the explanation is continued supposing that the registered person 60 accepted the delivery request. The registered person 60 travels to the designated delivery destination-supporting geographical point by a time designated by the managing server 100.

At S110, the managing server 100 sends a transport instruction about the package 80 to the superordinate vehicle 200. At S112, the superordinate vehicle 200 transports the package 80 to the delivery destination-supporting geographical point. The superordinate vehicle 200 may transport the package 80 to the delivery destination-supporting geographical point on its own, or may make a subordinate vehicle 300 transport the package 80. For example, the superordinate vehicle 200 travels to one of a plurality of delivery destination-supporting geographical points, and makes a subordinate vehicle 300 transport a package 80 to another delivery destination-supporting geographical point among the plurality of delivery destination-supporting geographical points.

At S114, verification is performed between the superordinate vehicle 200 or a subordinate vehicle 300 having arrived at the delivery destination-supporting geographical point and the registered person 60 having arrived at the delivery destination-supporting geographical point. For example, the superordinate vehicle 200 or the subordinate vehicle 300 reads out terminal identification information from the mobile communication terminal 600 of the registered person 60 having arrived at the delivery destination-supporting geographical point. If it matches terminal identification information of the mobile communication terminal 600 of the registered person 60 that had been received from the managing server 100, it is determined that the verification succeeded, and if not, it is determined that the verification failed. The verification method is not limited to this, but any method may be employed. Here, the explanation is continued supposing that it is determined that the verification succeeded.

At S116, the registered person 60 receives the package 80 from the superordinate vehicle 200 or the subordinate vehicle 300. At S118, the registered person 60 delivers the package 80 received at S116 to a delivery destination designated by the managing server 100.

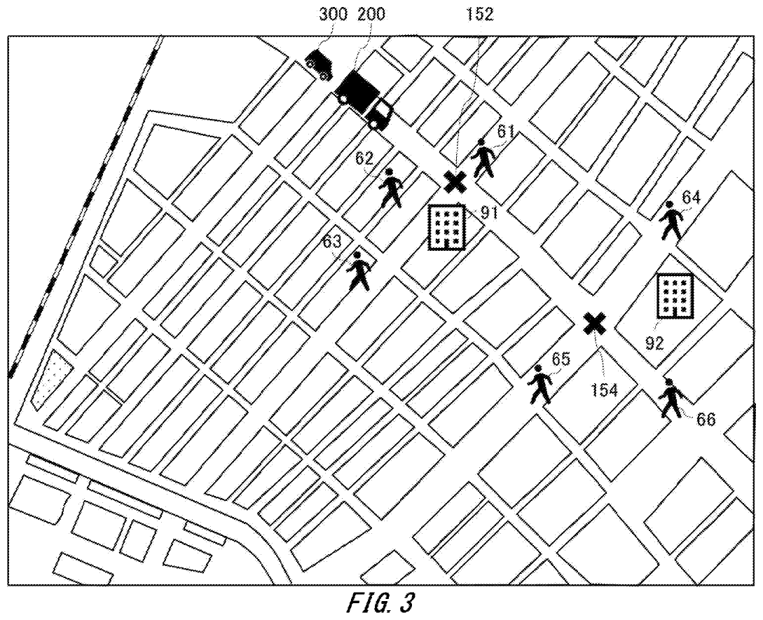

FIG. 3 is an explanatory figure for explaining contents of processing to be performed by the delivery system 10. Here, contents of processing to be performed when packages 80 are delivered to a residence in a multi-dwelling unit 91 and a residence in a multi-dwelling unit 92 are explained. In the example explained here, a registered person 61, a registered person 62, and a registered person 63 are positioned in an area that is within a predetermined range from the multi-dwelling unit 91, and a registered person 64, a registered person 65, and a registered person 66 are positioned in an area that is within a predetermined range from the multi-dwelling unit 92.

The managing server 100 decides a delivery destination-supporting geographical point 152 corresponding to the multi-dwelling unit 91 based on the position of the multi-dwelling unit 91. In addition, the managing server 100 decides a delivery destination-supporting geographical point 154 corresponding to the multi-dwelling unit 92 based on the position of the multi-dwelling unit 92.

In addition, the managing server 100 selects a registered person 60 from the plurality of registered persons 60 who is to deliver the package 80 from the delivery destination-supporting geographical point 152 to a delivery destination. The managing server 100 may select a registered person 60 based on the positions of the plurality of registered persons 60. For example, the managing server 100 selects a registered person 60 among the plurality of registered persons 60 who is closest to the delivery destination-supporting geographical point 152. In the example illustrated in FIG. 3, the managing server 100 may select the registered person 61. For example, the managing server 100 notifies the registered person 61 of: the position of the delivery destination-supporting geographical point 152; a scheduled time of arrival of the package 80 at the delivery destination-supporting geographical point 152; a feature of the superordinate vehicle 200, the position of the multi-dwelling unit 91; and information about a residence in the multi-dwelling unit 91 which is the delivery destination.

In addition, the managing server 100 selects a registered person 60 from the plurality of registered persons 60 who is to deliver the package 80 from the delivery destination-supporting geographical point 154 to a delivery destination. The managing server 100 may select a registered person 60 based on the positions of the plurality of registered persons 60. For example, the managing server 100 selects a registered person 60 among the plurality of registered persons 60 who is closest to the delivery destination-supporting geographical point 154. In the example illustrated in FIG. 3, the managing server 100 may select the registered person 64. For example, the managing server 100 notifies the registered person 64 of: the position of the delivery destination-supporting geographical point 154; a scheduled time of arrival of the package 80 at the delivery destination-supporting geographical point 154; a feature of the subordinate vehicle 300, the position of the multi-dwelling unit 92; and information about a residence in the multi-dwelling unit 92 which is the delivery destination.

The managing server 100 may make the superordinate vehicle 200 transport the package 80 to the delivery destination-supporting geographical point 152 by automated transportation. In addition, the managing server 100 may make the subordinate vehicle 300 transport the package 80 to the delivery destination-supporting geographical point 154 by automated transportation.

If a delivery destination is a multi-dwelling unit, automated transportation by a subordinate vehicle 300 cannot carry a package 80 to the entrance of a residence in some cases, and for example it becomes necessary to ask the recipient to come out to the entrance of the multi-dwelling unit to pick up the package 80 in some cases. In contrast, with the delivery system 10 according to the present embodiment, the package 80 is automatically transported halfway to a certain point, and the package 80 can be carried by a registered person 60 to the delivery destination residence, thereby improving the convenience for the recipient. In addition, by making not a full-time courier belonging to a delivery company, but a registered person 60 carry the package 80, the burden on the delivery company can be reduced, and the overall delivery efficiency can be enhanced.

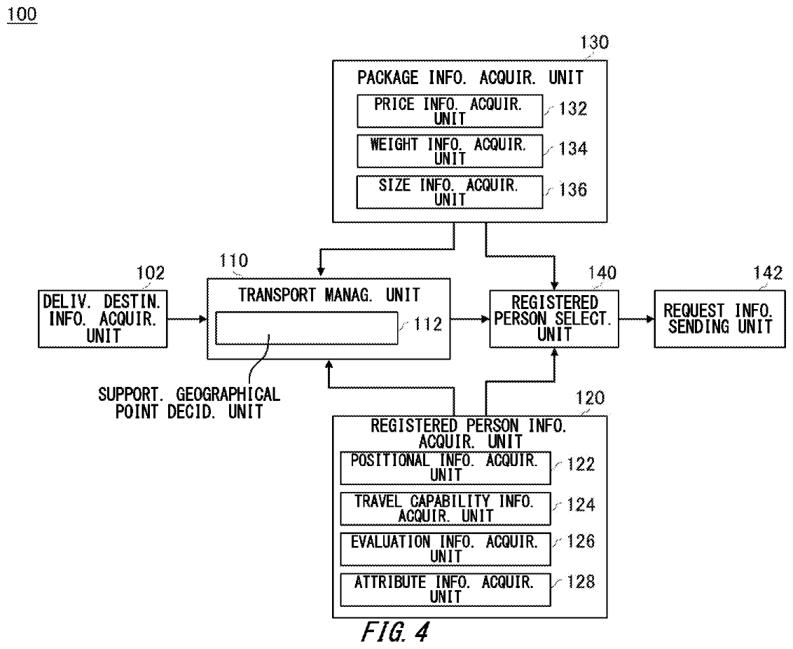

FIG. 4 schematically illustrates an exemplary functional configuration of the managing server 100. The managing server 100 includes a delivery destination information acquiring unit 102, a transport managing unit 110, a registered person information acquiring unit 120, a package information acquiring unit 130, a registered person selecting unit 140, and a request information sending unit 142.

The delivery destination information acquiring unit 102 acquires delivery destination information. The delivery destination information acquiring unit 102 acquires delivery destination information of a package 80 loaded onto the superordinate vehicle 200, for example. In addition, the delivery destination information acquiring unit 102 acquires delivery destination information of a package 80 loaded onto a delivery vehicle 400, for example.

Based on the delivery destination information acquired by the delivery destination information acquiring unit 102, the transport managing unit 110 performs management to transport the package 80 by automated transportation by the superordinate vehicle 200 to a delivery destination-supporting geographical point corresponding to the delivery destination of the package 80. For example, the transport managing unit 110 sends, to the superordinate vehicle 200, a transport instruction including the delivery destination-supporting geographical point, and a time by which the package 80 is transported to the delivery destination-supporting geographical point. The superordinate vehicle 200 transports the package 80 to the delivery destination-supporting geographical point by the designated time according to the transport instruction.

In addition, based on the delivery destination information acquired by the delivery destination information acquiring unit 102, the transport managing unit 110 performs management to transport the package 80 by automated transportation by the superordinate vehicle 200 and a subordinate vehicle 300 to a delivery destination-supporting geographical point corresponding to the delivery destination of the package 80. For example, the transport managing unit 110 sends, to the superordinate vehicle 200, a transport instruction including the delivery destination-supporting geographical point, and a time by which the package 80 is transported to the delivery destination-supporting geographical point. The superordinate vehicle 200 makes the subordinate vehicle 300 transport the package 80 to the delivery destination-supporting geographical point by the designated time.

In addition, based on the delivery destination information acquired by the delivery destination information acquiring unit 102, the transport managing unit 110 performs management to make a courier use a delivery vehicle 400 to transport the package 80 to the delivery destination-supporting geographical point corresponding to the delivery destination of the package 80. For example, the transport managing unit 110 sends, to a mobile communication terminal owned by the courier, a transport instruction including the delivery destination-supporting geographical point, and a time by which the package 80 is transported to the delivery destination-supporting geographical point. The courier uses the delivery vehicle 400 to transport the package 80 to the delivery destination-supporting geographical point by the designated time.

The transport managing unit 110 has a supporting geographical point deciding unit 112. The supporting geographical point deciding unit 112 decides a delivery destination-supporting geographical point based on the delivery destination information of a package 80. The supporting geographical point deciding unit 112 may decide a delivery destination-supporting geographical point based on the delivery destination information, and the positions of a plurality of registered persons 60.

For example, the supporting geographical point deciding unit 112 decides the delivery destination-supporting geographical point from an area which is a region identified by the delivery destination of the package 80 and where there are a larger number of registered persons 60. The region identified by the delivery destination of the package 80 may be, for example, a region within a range that covers a predetermined distance from the delivery destination of the package 80. The predetermined distance may be set and altered arbitrarily.

The supporting geographical point deciding unit 112 may decide a delivery destination-supporting geographical point for each of the delivery destinations of a plurality of packages 80. In addition, the supporting geographical point deciding unit 112 may decide one delivery destination-supporting geographical point for the delivery destinations of the plurality of packages 80. For example, the supporting geographical point deciding unit 112 may decide the delivery destination-supporting geographical point from an area which is in a region identified by the delivery destinations of the plurality of packages 80 and where there are a larger number of registered persons 60. The region identified by the delivery destinations of the plurality of packages 80 may be, for example, a region that covers the delivery destinations of the plurality of packages 80.

The registered person information acquiring unit 120 acquires various types of information related to registered persons 60. The registered person information acquiring unit 120 has a positional information acquiring unit 122, a travel capability information acquiring unit 124, an evaluation information acquiring unit 126, and an attribute information acquiring unit 128.

The positional information acquiring unit 122 acquires positional information indicating the positions of the registered persons 60. The positional information acquiring unit 122 may receive positional information of a mobile communication terminal 600 of a registered person 60 from the mobile communication terminal 600 as positional information of the registered person 60.

The travel capability information acquiring unit 124 acquires travel capability information indicating the travel capabilities of the registered persons 60. The supporting geographical point deciding unit 112 may decide a delivery destination-supporting geographical point based on the travel capability information acquired by the travel capability information acquiring unit 124. For example, the supporting geographical point deciding unit 112 decides the delivery destination-supporting geographical point from an area which is in a region identified by delivery destination information of a package 80, and where there are a large number of registered persons 60 with higher travel capabilities.

The evaluation information acquiring unit 126 acquires evaluation information indicating evaluation results of the registered persons 60. The managing server 100 may register evaluation results based on delivery achievement of each of the plurality of registered persons 60. Evaluation results may be decided based on the number of times deliveries are performed, lengths of time required for deliveries, results of evaluation by the recipients of packages 80, and the like. The evaluation information acquiring unit 126 may acquire evaluation results registered in the managing server 100.

The attribute information acquiring unit 128 acquires attribute information of registered persons 60. The attribute information acquiring unit 128 acquires an indication of the genders of registered persons 60, for example. In addition, the attribute information acquiring unit 128 acquires an indication of the ages of registered persons 60, for example. Note that the attribute information acquiring unit 128 may acquire attribute information of the recipients of packages 80. The attribute information acquiring unit 128 acquires attribute information of recipients registered in the managing server 100 by the senders of packages 80, for example.

The package information acquiring unit 130 acquires package information about delivery target packages 80. The package information acquiring unit 130 has a price information acquiring unit 132, a weight information acquiring unit 134, and a size information acquiring unit 136.

The price information acquiring unit 132 acquires price information indicating the prices of packages 80.

The price information may be information indicating the monetary values of packages 80 with numerical values. In addition, the price information may be information indicating price-based classification such as high, normal, or low. The price information acquiring unit 132 acquires price information registered by the senders of packages 80, for example.

The weight information acquiring unit 134 acquires weight information related to the weights of packages 80. The weight information may be information indicating the weights with numerical values in grams, kilograms, or the like. In addition, the weight information may be information indicating weight-based classification such as heavy, normal, or light.

The size information acquiring unit 136 acquires size information related to the sizes of packages 80. The size information may be information indicating the dimensions of the packages 80 with numerical values. In addition, the size information may be information indicating size-based classification such as large, normal, or small.

The registered person selecting unit 140 selects a registered person 60 from a plurality of registered persons 60 who is to deliver a package 80 transported to a delivery destination-supporting geographical point from the delivery destination-supporting geographical point to the delivery destination. The registered person selecting unit 140 may select a registered person 60 based on positional information of a plurality of registered persons 60 acquired by the positional information acquiring unit 122. For example, the registered person selecting unit 140 selects a registered person 60 among the plurality of registered persons 60 who is closest to a delivery destination-supporting geographical point.

The registered person selecting unit 140 may select a registered person 60 based on price information acquired by the price information acquiring unit 132. The registered person selecting unit 140 selects a registered person 60 based on price information, and evaluation information acquired by the evaluation information acquiring unit 126, for example. For example, for a package 80 whose price price information indicates is higher, the registered person selecting unit 140 preferentially selects a registered person 60 having better evaluation results indicated by evaluation information. In addition, for example, if the price indicated by price information is higher than a predetermined threshold, the registered person selecting unit 140 selects a registered person 60 from registered persons 60 who evaluation information indicates has evaluation results that are better than a predetermined threshold.

The registered person selecting unit 140 may select a registered person 60 based on attribute information acquired by the attribute information acquiring unit 128. For example, the registered person selecting unit 140 selects a registered person 60 based on attribute information, and weight information acquired by the weight information acquiring unit 134. For example, for a package 80 whose weight weight information indicates is heavier than a predetermined weight, the registered person selecting unit 140 preferentially selects a registered person 60 whose gender attribute information indicates is male. In addition, for example, for a package 80 whose weight weight information indicates is heavier than a predetermined weight, the registered person selecting unit 140 selects a registered person 60 who attribute information indicates is at an age that is among ages that are considered as being related to people who are strong enough, such as those in their teens, twenties, and thirties, as compared to people at other ages.

In addition, for example, the registered person selecting unit 140 selects a registered person 60 based on attribute information, and size information acquired by the size information acquiring unit 136. For example, for a package 80 whose size size information indicates is larger than a predetermined size, the registered person selecting unit 140 preferentially selects as registered person 60 whose gender attribute information indicates is male. In addition, for example, for a package 80 whose size size information indicates is larger than a predetermined size, the registered person selecting unit 140 selects a registered person 60 who attribute information indicates is at an age that is among ages that are considered as being related to people who are strong enough, such as those in their teens, twenties, and thirties, as compared to people at other ages.

The registered person selecting unit 140 may select a registered person 60 based on attribute information of the recipient of a package 80, and attribute information of registered persons 60. The registered person selecting unit 140 selects a registered person 60 whose gender is the same as the recipient of a package 80, for example. For example, if the gender of the recipient of a package 80 is female, the registered person selecting unit 140 selects a registered person 60 whose gender attribute information indicates is female. In addition, for example, if the gender of the recipient of a package 80 is male, the registered person selecting unit 140 selects a registered person 60 whose gender attribute information indicates is male.

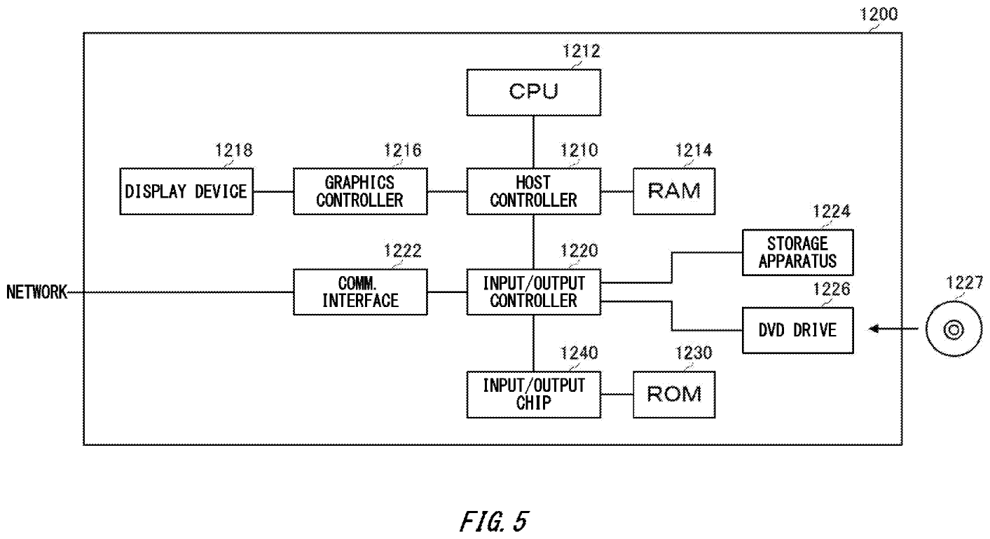

FIG. 5 schematically illustrates an exemplary hardware configuration of a computer 1200 to function as the managing server 100. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage apparatus 1224, a DVD drive 1226 and an IC card drive, which are connected to the host controller 1210 via an input/output controller 1220. The DVD drive 1226 may be a DVD-ROM drive, a DVD-RAM drive, or the like. The storage apparatus 1224 may be a hard disk drive, a solid state drive, or the like. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network. The storage apparatus 1224 stores programs and data used by the CPU 1212 within the computer 1200. The DVD drive 1226 reads the programs or the data from the DVD-ROM 1227, and the like, and provides the storage apparatus 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, and the like to the input/output controller 1220.

A program is provided by computer-readable storage media such as the DVD-ROM 1227 or the IC card. The program is read from the computer-readable storage media, installed into the storage apparatus 1224, RAM 1214, or ROM 1230, which are also examples of computer-readable storage media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the storage apparatus 1224, the DVD-ROM 1227, or the IC card, and transmits the read transmission data to a network or writes reception data received from a network to a reception buffering region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer-readable storage media on or near the computer 1200. In addition, a recording medium such as a hard disk or a RAM provided in a server system connected to a dedicated communication network or the Internet can be used as the computer-readable storage media, thereby providing the program to the computer 1200 via the network.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable storage media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: delivery system; 20: network; 60, 61, 62, 63, 64, 65, 66: registered person; 80: package; 91, 92: multi-dwelling unit; 100: managing server; 102: delivery destination information acquiring unit; 110: transport managing unit; 112: supporting geographical point deciding unit; 120: registered person information acquiring unit; 122: positional information acquiring unit; 124: travel capability information acquiring unit; 126: evaluation information acquiring unit; 128: attribute information acquiring unit; 132: price information acquiring unit; 134: weight information acquiring unit; 136: size information acquiring unit; 140: registered person selecting unit; 142: request information sending unit; 152, 154: delivery destination-supporting geographical point; 200: superordinate vehicle; 201: housing unit; 300: subordinate vehicle; 400: delivery vehicle; 600: mobile communication terminal; 1200: computer; 1210: host controller; 1212: CPU; 1214: RAM; 1216: graphics controller; 1218: display device; 1220: input/output controller; 1222: communication interface; 1224: storage apparatus; 1226: DVD drive; 1227: DVD-ROM; 1230: ROM; 1240: input/output chip

What is claimed is:

1. A delivery system comprising:
a superordinate vehicle that transports a plurality of packages, and is capable of automated driving;
a subordinate vehicle that transports a package received from the superordinate vehicle, and is capable of automated driving; and
a managing server that manages delivery of a package, wherein
the managing server has:
a delivery destination information acquiring unit that acquires delivery destination information related to a delivery destination of a package;
a transport managing unit that performs management to make the package transport by the superordinate vehicle and the subordinate vehicle by automated transportation to a delivery destination-supporting geographical point corresponding to the delivery destination of the package based on the delivery destination information; and
a registered person selecting unit that selects a registered person to deliver the package having been transported to the delivery destination-supporting geographical point, the registered person being selected from a plurality of pre-registered registered persons, the package being delivered from the delivery destination-supporting geographical point to the delivery destination.

2. The delivery system according to claim 1, wherein the registered person is registered for a job of operating as a courier temporarily.

3. The delivery system according to claim 1, wherein the managing server has a request information sending unit that sends request information for requesting delivery of the package, to a communication terminal corresponding to the registered person selected by the registered person selecting unit.

4. The delivery system according to claim 1, wherein
the managing server has a positional information acquiring unit that acquires positional information of each registered person among the plurality of registered persons, wherein
the registered person selecting unit selects the registered person to deliver the package from the delivery destination-supporting geographical point to the delivery destination based on positional information of the plurality of registered persons.

5. The delivery system according to claim 4, wherein
the managing server has a supporting geographical point deciding unit that decides the delivery destination-supporting geographical point, and
the supporting geographical point deciding unit decides the delivery destination-supporting geographical point based on the delivery destination information and the positional information of the plurality of registered persons.

6. The delivery system according to claim 5, wherein the supporting geographical point deciding unit decides the delivery destination-supporting geographical point from an area which is in a region identified by delivery destination information of a plurality of packages and where there are a larger number of registered persons.

7. The delivery system according to claim 5, wherein
the managing server has a travel capability information acquiring unit that acquires travel capability information indicating a travel capability of each registered person among the plurality of registered persons, and
the supporting geographical point deciding unit decides the delivery destination-supporting geographical point from an area which is in a region identified by delivery destination information of a plurality of packages, and where there are a larger number of registered persons with higher travel capabilities.

8. The delivery system according to claim 1, wherein
the managing server has a price information acquiring unit that acquires price information related to a price of the package, and
the registered person selecting unit selects the registered person to deliver the package to the delivery destination based on the price information of the package.

9. The delivery system according to claim 8, wherein
the managing server has an evaluation information acquiring unit that acquires evaluation information about each registered person among the plurality of registered persons, and
the registered person selecting unit selects the registered person to deliver the package to the delivery destination based on the price information of the package and the evaluation information.

10. The delivery system according to claim 1, wherein
the managing server has an attribute information acquiring unit that acquires attribute information including a gender and age of each registered person among the plurality of registered persons, and
the registered person selecting unit selects the registered person to deliver the package to the delivery destination based on the attribute information.

11. The delivery system according to claim 10, wherein
the managing server has a weight information acquiring unit that acquires weight information related to a weight of the package, and
the registered person selecting unit selects the registered person to deliver the package to the delivery destination based on the attribute information and the weight information.

12. The delivery system according to claim 10, wherein
the attribute information acquiring unit acquires attribute information of a recipient of the package, and
the registered person selecting unit selects the registered person to deliver the package to the delivery destination based on attribute information of each registered person among the plurality of registered persons and the attribute information of the recipient of the package.

13. A managing server comprising:
a delivery destination information acquiring unit that acquires delivery destination information related to a delivery destination of a package;
a transport managing unit that performs management to make the package transported to a delivery destination-supporting geographical point corresponding to the delivery destination of the package based on the delivery destination information; and
a registered person selecting unit that selects a registered person to deliver the package having been transported to the delivery destination-supporting geographical point, the registered person being selected from a plurality of pre-registered registered persons, the package being delivered from the delivery destination-supporting geographical point to the delivery destination.

14. The managing server according to claim 13, wherein
the registered person is registered for a job of operating as a courier temporarily
the managing server comprises a positional information acquiring unit that acquires positional information of each registered person among the plurality of registered persons, wherein
the registered person selecting unit selects the registered person to deliver the package from the delivery destination-supporting geographical point to the delivery destination based on positional information of the plurality of registered persons.

15. A non-transitory computer-readable storage medium having stored thereon a program for making a computer function as:
a delivery destination information acquiring unit that acquires delivery destination information related to a delivery destination of a package;
a transport managing unit that performs management to make the package transported to a delivery destination-supporting geographical point corresponding to the delivery destination of the package based on the delivery destination information; and
a registered person selecting unit that selects a registered person to deliver the package having been transported to the delivery destination-supporting geographical point, the registered person being selected from a plurality of pre-registered registered persons, the package being delivered from the delivery destination-supporting geographical point to the delivery destination.

16. A management method executed by a computer, the management method comprising:
acquiring delivery destination information related to a delivery destination of a package;
performing management to make the package transported to a delivery destination-supporting geographical point corresponding to the delivery destination of the package based on the delivery destination information; and
selecting a registered person to deliver the package having been transported to the delivery destination-supporting geographical point, the registered person being selected from a plurality of pre-registered registered persons, the package being delivered from the delivery destination-supporting geographical point to the delivery destination.
